(19) United States
(12) Patent Application Publication
(10) Pub. No.: US 2013/0318509 A1
(43) Pub. Date: Nov. 28, 2013

(54) GENERATING OBJECT CODE FROM A CONJOINED ASSEMBLER DIRECTIVE

(71) Applicants: DAVID J. HARMAN, HURSLEY (GB); NEIL W. LEEDHAM, SOUTHAMPTON (GB); MARK WILLIAM TRAFFORD TODD, WINCHESTER (GB); ANDREW WRIGHT, EASTLEIGH (GB)

(72) Inventors: DAVID J. HARMAN, HURSLEY (GB); NEIL W. LEEDHAM, SOUTHAMPTON (GB); MARK WILLIAM TRAFFORD TODD, WINCHESTER (GB); ANDREW WRIGHT, EASTLEIGH (GB)

(73) Assignee: INTERNATIONAL BUSINESS MACHINES CORPORATION, ARMONK, NY (US)

(21) Appl. No.: 13/477,801

(22) Filed: May 22, 2012

(51) Int. Cl. G06F 9/45

(52) U.S. Cl. 717/140

(57) ABSTRACT

Receiving assembly language source code for a computer program and identifying within the assembly language source code a conjoined directive that conjoins a load instruction and an assembler directive. The conjoined directive can identify a data structure, a first register, and a second register that contains an address of a location in memory that contains the data structure. Via a processor, the conjoined directive can be processed to create object code that includes operation code that loads into the first register the address of the location in memory that contains the data structure. The object code can be output.

### BACKGROUND

Arrangements described herein relate to generating operation code from source code written in assembly language.

Assembly language, sometimes referred to as assembler language, is a low-level programming language for computers, microprocessors, microcontrollers, and other programmable devices in which each statement corresponds to a single machine language instruction. Assembly Language syntax uses instructions that contain mnemonic processor instructions. An assembler is used to create object code from assembly language source code by translating each mnemonic processor instruction into operation code, which is the portion of a machine language instruction that specifies an operation to be performed. Since assembly language allows the programmer to create source code that directly maps to object code, it is a powerful way of developing program code that is very close to the underlying hardware and architecture, and thus operates very efficiently.

Since the advent of high level programming languages (e.g., Fortran, Pascal, Basic, C, C++, Java, etc.) the use of assembly language for computer programming has declined, however. Nonetheless, there are areas where assembly language still is used. For example, when program code must operate extremely efficiently, a computer programmer may choose to write the program code in assembly language. Further, there are certain computer programs that have existed for many years and still contain parts of their component structure that are written in assembly language. Some of these computer programs are serviced and/or extended from time to time using assembly language.

### BRIEF SUMMARY

One or more embodiments disclosed within this specification relate to generating object code from source code.

An embodiment can include receiving assembly language source code for a computer program and identifying within the assembly language source code a conjoined directive that conjoins a load instruction and an assembler directive. The conjoined directive can identify a data structure, a first register, and a second register that contains an address of a location in memory that contains the data structure. Via a processor, the conjoined directive can be processed to create object code that includes operation code that loads into the first register the address of the location in memory that contains the data structure. The object code can be output.

Another embodiment can include a system having a processor. The processor can be configured to initiate executable operations including receiving assembly language source code for a computer program and identifying within the assembly language source code a conjoined directive that conjoins a load instruction and an assembler directive. The conjoined directive can identify a data structure, a first register, and a second register that contains an address of a location in memory that contains the data structure. The processor can process the conjoined directive to create object code that includes operation code that loads into the first register the address of the location in memory that contains the data structure. The processor can output the object code.

Another embodiment can include a computer program product. The computer program product can include a computer-readable storage medium having stored thereon program code that, when executed, configures a processor to perform operations including receiving assembly language source code for a computer program and identifying within the assembly language source code a conjoined directive that conjoins a load instruction and an assembler directive. The conjoined directive can identify a data structure, a first register, and a second register that contains an address of a location in memory that contains the data structure. The program code further can configure the processor to process the conjoined directive to create object code that includes operation code that loads into the first register the address of the location in memory that contains the data structure. The program code further can configure the processor to output the object code.

### BRIEF DESCRIPTION OF THE SEVERAL VIEWS OF THE DRAWINGS

FIG. 1 is a flow diagram illustrating the generation of object code from source code in accordance with one embodiment disclosed within this specification.

FIG. 2 is a block diagram illustrating a processing system for generating object code from source code in accordance with one embodiment disclosed within this specification.

FIG. 3 is a flow chart illustrating a method of generating object code from source code in accordance with another embodiment disclosed within this specification.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in a programming language suitable for creating assemblers.

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Arrangements described herein relate to generating object code from source code written in assembly language. More particularly, the source code can include at least one conjoined directive that is a combination of a load instruction and an assembler directive. When the source code is processed by an assembler, the assembler can process the conjoined directive to create object code that includes an operation code related to loading the register using data identified by the assembler directive, and the assembler can output the object code.

As used herein, the term “assembler” means a computer program, executable by a processor, which creates object code by translating assembly language processor instructions into operation codes. An assembler also can resolve symbolic names for memory locations and other entities.

As used herein, the term “load instruction” means an assembly language processor instruction that specifies a run-time operation to be performed by operation code within object code when executed by a processor to load a memory address of a data structure into a register.

As used herein, the term “assembler directive” means an instruction that specifies an assembly-time operation executed by an assembler when assembling object code from source code. An assembler directive does not specify operation code executed at run-time by a processor executing object code. For example, an assembler directive can indicate to an assembler that if various fields are referenced in the source code, the fields are to be mapped from the register using a particular offset.

As used herein, the term “conjoined directive” means an assembly language instruction that specifies at least one assembly language processor instruction and at least one assembler directive.

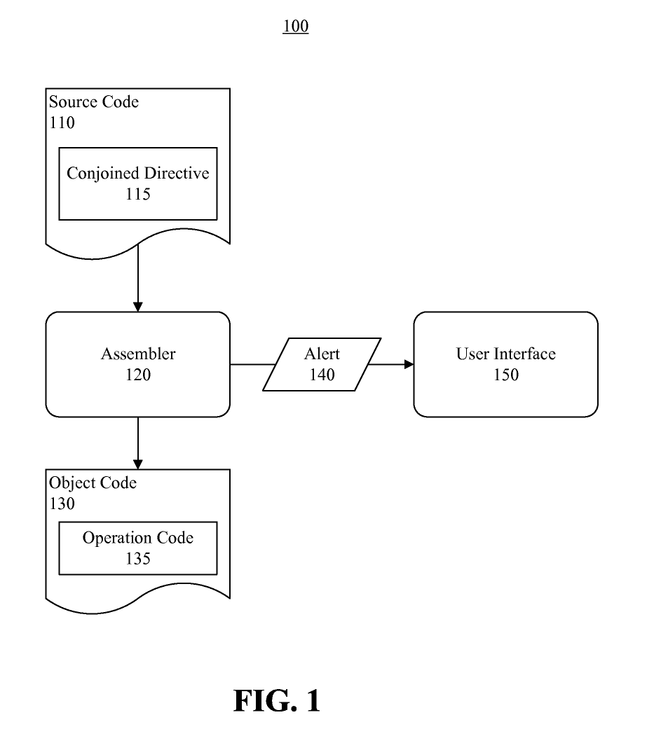

FIG. 1 is a flow diagram 100 illustrating the generation of object code 130 from source code 110 in accordance with one embodiment disclosed within this specification. The source code 110 can include at least one conjoined directive 115 which includes a load instruction and an assembler directive. To facilitate understanding of the conjoined directive 115, reference is made to Table 1, which includes source code written in accordance with the prior art.

TABLE 1

SPACE,
USING DATA_AREA_1,R15
L R15,DATA_AREA_1_POINTER
SPACE,

The source code of Table 1 includes a USING assembler directive with parameters “R15” and “DATA_AREA_{—}1”. The parameter R15 can identify a register 15 (e.g., a base register), and the parameter DATA_AREA_{—}1 can identify a data structure to be mapped to the register 15. The USING assembler directive can map register 15 to the data structure. The source code also includes a load instruction (“L”) with parameters “R15” and “DATA_AREA_{—}1_POINTER”. Again, the parameter “R15” can identify the register. The DATA_AREA_{—}1_POINTER parameter can be a named field that contains the address of the location in memory that contains the data structure. The load instruction can load/initialize register 15 with the address of the memory location contained in the named field identified by the DATA_AREA_{—}1_POINTER parameter.

In accordance with the present arrangements, the directive and load instructions can be conjoined into a conjoined directive 115. The syntax of the conjoined directive can be, for example:
LUSING DSECTx,Rx,PTRx
   where LUSING is the conjoined directive and “DSECTx”, “Rx”, and “PTRx” are parameters used with the conjoined directive. “DSECTx” can identify a data structure, “Rx” can be a register (e.g., base register), and “PTRx” can be a named field that contains the address of the location in memory that contains the data structure. Accordingly, rather than using a separate load instruction and assembler directive, these can be conjoined into a single statement using a single line of source code to both map the data structure to the register Rx and load/initialize register Rx with the address of the memory location that contains the data structure mapped by DSECTx.

Table 2 includes an example source code written in accordance with the present arrangements.

TABLE 2

SPACE 1,
LUSING DATA_AREA_1,R15,DATA_AREA_1_POINTER
SPACE
...
DROP R15

In this example, the “DATA_AREA_{—}1” is the DSECTx parameter identifying a data structure, “R15” is the Rx parameter identifying a register (e.g., base register), and the “DATA_AREA_{—}1_POINTER” is the PTRx parameter and is a named field that contains the address of the location in memory to be mapped to the data structure. The LUSING conjoined directive maps the data structure to the register and loads/initializes the register with the memory location that contains the data structure being mapped.

In the example presented in Table 2, the ellipse (“ . . . ”) below the term “SPACE” indicates where additional code can be used to reference fields in the data structure. A traditional DROP assembler directive (e.g., “DROP R15”) can be used to terminate the scope of the LUSING conjoined directive. For example, the DROP assembler directive can indicate that the register no longer references the data structure. In comparison to table 1, the single conjoined directive “LUSING” includes both the “USING” directive and the load instruction “L”, and is used in place of an individual “USING” directive and an individual load instruction “L”.

Other load instructions also can be conjoined with an assembler directive to create a conjoined directive. For example, the load address (“LA”) load instruction can be conjoined with the “USING” directive as “LAUSING”, the load register (“LR”) load instruction can be conjoined with the “USING” directive as “LRUSING”, and the insert character under mask (“ICM”) load instruction can be conjoined with the “USING” directive as “ICMUSING”. Still, other load instructions can be combined with the “USING” directive to form a conjoined directive, and the present embodiments are not limited in this regard. All of these variants can use named field or explicit base register plus offset notations, which would be understood to those skilled in the art.

At assembly-time, the source code 110 can be input to the assembler 120, which can translate the source code 110 into object code 130. The object code 130 can include operation code 135 that is a translation of the load instruction contained in the conjoined directive 115, as well as operation codes corresponding to other processor instructions contained in the source code 110. The operation code 135 can be configured to map the identified data structure into a register identified by the pointer. The assembler directive contained in the conjoined directive 115 is used by the assembler 120 to generate the object code 130, but the assembler directive is not present in the object code 130.

Because the conjoined directive 115 includes the assembler directive with the load instruction, the computer programmer need only enter a single line of code in the source code 110 to implement these programming elements. Moreover, the risk of the computer programmer implementing a load instruction without a required assembler directive is mitigated. Further, the risk of the computer programmer identifying different registers in an assembler directive and a corresponding load instruction, which can result in object code errors, also is mitigated.

In this regard, at assembly-time, the assembler 120 can identify any assembler directives, and generate an alert 140 to a user interface 150 to indicate to a user (e.g., a computer programmer) to verify whether the assembler directives should be provided in conjoined directives that include corresponding load instructions. The alert 140 can identify the particular lines of code in which such assembler directives are contained in the source code 110. Further, the alert 140 can recommend to the user to use conjoined directives 115 in lieu of the assembler directives.

The assembler 120 also can identify any assembly directives associated with load instructions, and determine whether the registers identified in the assembly directives correspond to registers identified in corresponding load instructions. If not, the assembler 120 can generate the alert 140 indicating that the registers identified in the assembly directives do not correspond to registers identified in corresponding load instructions. Again, the alert 140 can recommend to the computer programmer to use conjoined directive 115 in lieu of the assembly directives.

In one non-limiting embodiment, the assembler 120 can include a macro that expands the conjoined directive(s) into the load instruction(s) and the assembler directive(s) prior to translating the source code 110 to the object code 130. In one arrangement, the conjoined directive(s) can include syntax that initiates the macro. In another arrangement, the assembler 120 can otherwise automatically identify the conjoined assembly directive(s).

In another arrangement, another application (not shown) can expand the conjoined directive(s) into the load instruction(s) and the assembler directive(s) prior to the assembler 120 translating the source code 110 to the object code 130. Again, the conjoined directive(s) can include syntax that initiates the expansion, or the other application can automatically identify the conjoined assembly directive(s).

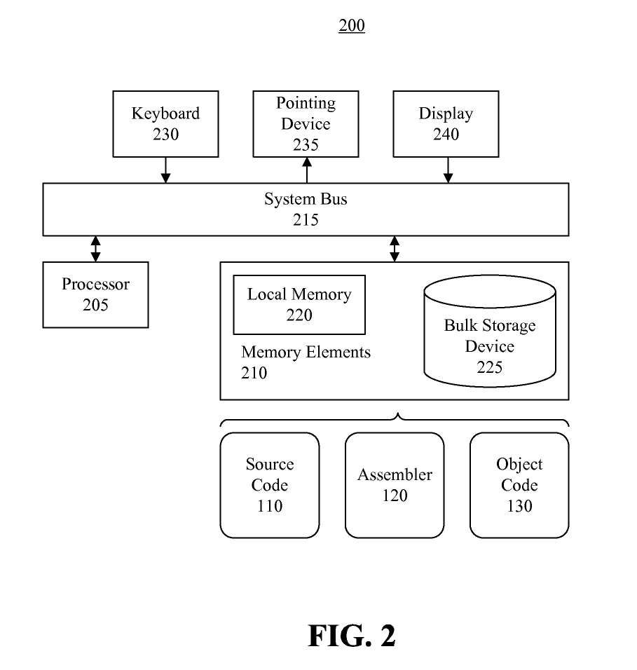

FIG. 2 is a block diagram illustrating a processing system (hereinafter “system”) 200 for generating object code from source code in accordance with one embodiment disclosed within this specification. The system 200 can include at least one processor 205 coupled to memory elements 210 through a system bus 215 or other suitable circuitry. As such, the system 200 can store program code within the memory elements 210. The processor 205 can execute the program code accessed from the memory elements 210 via a system bus 215. In one aspect, for example, the system 200 can be implemented as a computer that is suitable for storing and/or executing program code. It should be appreciated, however, that the system 200 can be implemented in the form of any system including a processor and memory that is capable of performing the functions and/or operations described within this specification.

The memory elements 210 can include one or more physical memory devices such as, for example, local memory 220 and one or more bulk storage devices 225. Local memory 220 refers to RAM or other non-persistent memory device(s) generally used during actual execution of the program code. Bulk storage device(s) 225 can be implemented as a hard disk drive (HDD), solid state drive (SSD), or other persistent data storage device(s). The system 200 also can include one or more cache memories (not shown) that provide temporary storage of at least some program code in order to reduce the number of times program code must be retrieved from the bulk storage device 225 during execution.

Input/output (I/O) devices such as a keyboard 230, a pointing device 235 and a display 240 can be coupled to the system 200. The user interface 150 of FIG. 1 can include the keyboard 230, the pointing device 235, the display 240 and/or any other user interface devices, including, but not limited to, input/output audio devices (not shown). The I/O devices can be coupled to the system 200 either directly or through intervening I/O controllers, and the system 200 can include suitable program code to manage the I/O devices. One or more network adapters (not shown) also can be coupled to the system 200 to enable the system 200 to become coupled to other systems, computer systems, remote printers, and/or remote storage devices through intervening private or public networks. Modems, cable modems, and Ethernet cards are examples of different types of network adapters that can be used with the system 200.

As pictured in FIG. 2, the memory elements 210 can store the source code 110, the assembler 120 and, when generated by the assembler 120, the object code 130. The assembler 120, being implemented in the form of executable program code, can be executed by the system 200 and, as such, can be considered part of the system 200.

The assembler 120 can process the source code 110 to generate the object code 130, as described herein. The object code 130 can be output to, and stored within, the memory elements 210 and/or written to the display 240. As used herein, “outputting” and/or “output” means storing in the memory elements 210, for example, writing to a file stored in the memory elements 210, writing to the display 240 or other peripheral output device, playing audible notifications, sending or transmitting to another system, exporting, or the like.

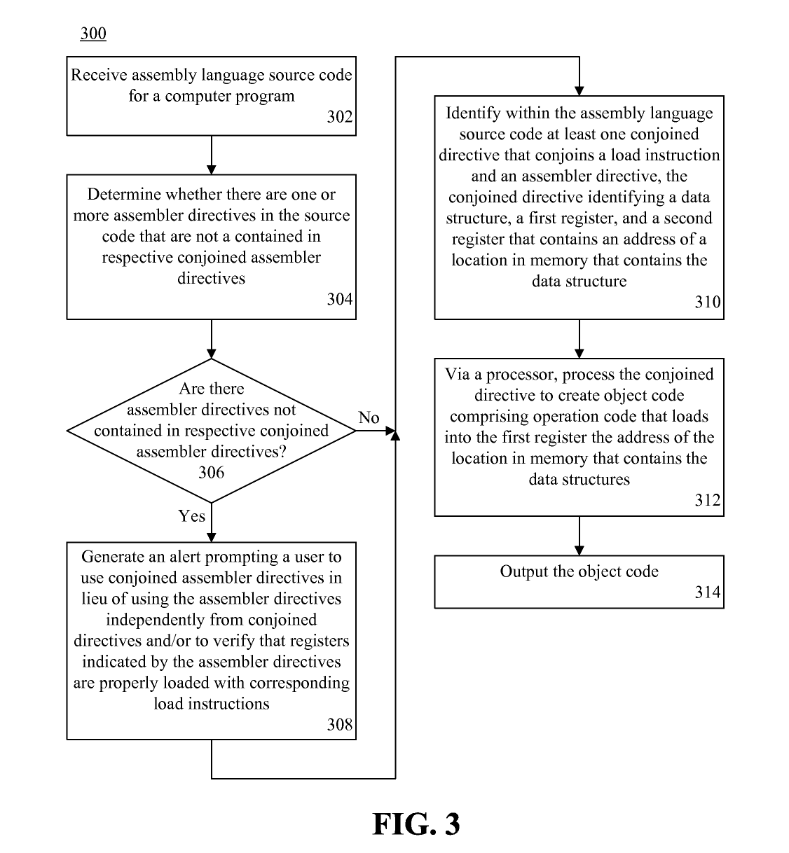

FIG. 3 is a flow chart illustrating a method 300 of generating object code from source code in accordance with another embodiment disclosed within this specification. At step 302, assembly language source code for a computer program can be received, for example by an assembler.

At step 304, a determination can be made as to whether there are one or more assembler directives in the source code that are not contained in respective conjoined directives. Referring to decision box 306, if there are one or more assembler directives in the source code that are not contained in respective conjoined directives, at step 308, an alert can be generated. The alert can prompt a user to use conjoined directives in lieu of the assembler directives that are independent of conjoined directives and/or to verify that registers indicated by the assembler directives are properly loaded with corresponding load instructions.

The process then can proceed to step 310. At step 310, within the assembly language source code, at least one conjoined directive can be identified. The conjoined directive can conjoin a load instruction and an assembler directive. Further, the conjoined directive can identify a data structure, a first register, and a second register that contains an address of a location in memory that contains the data structure.

At step 312, via a processor, the conjoined directive can be processed to create object code comprising operation code that loads into the first register the address of the location in memory that contains the data structures. If the assembly language source code comprises additional conjoined directives, such conjoined directives can be processed in a similar manner to generate corresponding operation codes within the object code. At step 314, the object code can be output.

Like numbers have been used to refer to the same items throughout this specification. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

What is claimed is:

1. A method of generating object code from source code, the method comprising:
receiving assembly language source code for a computer program;
identifying within the assembly language source code a conjoined directive that conjoins a load instruction and an assembler directive, the conjoined directive identifying a data structure, a first register, and a second register that contains an address of a location in memory that contains the data structure;
via a processor, processing the conjoined directive to create object code comprising operation code that loads into the first register the address of the location in memory that contains the data structure; and
outputting the object code.

2. The method of claim 1, wherein the load instruction and the assembler directive are contained in a single line of code.

3. The method of claim 1, wherein:
the load instruction specifies a run-time operation to be executed at runtime of the computer program; and
the assembler directive specifies an assembly-time operation to be implemented when the object code is created.

4. The method of claim 1, further comprising:
identifying that the assembler directive is not contained in the conjoined directive; and
responsive to identifying that the assembler directive is not contained in the conjoined directive, generating an alert prompting a user to use the conjoined directive in lieu of using the assembler directive independent of the conjoined directive.

5. The method of claim 1, further comprising:
identifying within the assembly language source code a second assembler directive that is not contained in a second conjoined directive; and
responsive to identifying the second assembler directive, generating an alert prompting a user to verify that a register indicated by the second assembler directive is properly loaded with a corresponding load instruction.

6. The method of claim 1, further comprising:
executing a macro that expands the conjoined directive into the load instruction and the assembler directive.

7. The method of claim 6, wherein the conjoined directive comprises syntax that initiates the macro.

8. A system comprising:
a processor configured to initiate executable operations comprising:
receiving assembly language source code for a computer program;
identifying within the assembly language source code a conjoined directive that conjoins a load instruction and an assembler directive, the conjoined directive identifying a data structure, a first register, and a second register that contains an address of a location in memory that contains the data structure;
processing the conjoined directive to create object code comprising operation code that loads into the first register the address of the location in memory that contains the data structure; and
outputting the object code.

9. The system of claim 8, wherein the load instruction and the assembler directive are contained in a single line of code.

10. The system of claim 8, wherein:
the load instruction specifies a run-time operation to be executed at runtime of the computer program; and
the assembler directive specifies an assembly-time operation to be implemented when the object code is created.

11. The system of claim 8, wherein the processor further is configured to initiate executable operations comprising:
identifying that the assembler directive is not contained in the conjoined directive; and
responsive to identifying that the assembler directive is not contained in the conjoined directive, generating an alert prompting a user to use the conjoined directive in lieu of using the assembler directive independent of the conjoined directive.

12. The system of claim 8, wherein the processor further is configured to initiate executable operations comprising:
identifying within the assembly language source code a second assembler directive that is not a contained in a second conjoined directive; and
responsive to identifying the second assembler directive, generating an alert prompting a user to verify that a register indicated by the second assembler directive is properly loaded with a corresponding load instruction.

13. The system of claim 8, wherein the processor further is configured to initiate executable operations comprising:
executing a macro that expands the conjoined directive into the load instruction and the assembler directive.

14. The system of claim 13, wherein the conjoined directive comprises syntax that initiates the macro.

15. A computer program product comprising:
a computer-readable storage medium having stored thereon program code that, when executed, configures a processor to perform executable operations comprising:
receiving assembly language source code for a computer program;
identifying within the assembly language source code a conjoined directive that conjoins a load instruction and an assembler directive, the conjoined directive identifying a data structure, a first register, and a second register that contains an address of a location in memory that contains the data structure;
processing the conjoined directive to create object code comprising operation code that loads into the first register the address of the location in memory that contains the data structure; and
outputting the object code.

16. The computer program product of claim 15, wherein the load instruction and the assembler directive are contained in a single line of code.

17. The computer program product of claim 15, wherein:
the load instruction specifies a run-time operation to be executed at runtime of the computer program; and
the assembler directive specifies an assembly-time operation to be implemented when the object code is created.

18. The computer program product of claim 15, wherein the program code further configures the processor to perform executable operations comprising:
identifying that the assembler directive is not contained in the conjoined directive; and
responsive to identifying that the assembler directive is not contained in the conjoined directive, generating an alert prompting a user to use the conjoined directive in lieu of using the assembler directive independent of the conjoined directive.

19. The computer program product of claim 15, wherein the program code further configures the processor to perform executable operations comprising:
identifying within the assembly language source code a second assembler directive that is not a contained in a second conjoined directive; and
responsive to identifying the second assembler directive, generating an alert prompting a user to verify that a register indicated by the second assembler directive is properly loaded with a corresponding load instruction.

20. The computer program product of claim 15, wherein the program code further configures the processor to perform executable operations comprising:
executing a macro that expands the conjoined directive into the load instruction and the assembler directive.
